(19) United States
(12) Patent Application Publication
(10) Pub. No.: US 2019/0034458 A1
(43) Pub. Date: Jan. 31, 2019

(54) SYSTEM AND METHOD FOR USE OF BUSINESS INTELLIGENCE FOR RULE BASED MANUFACTURING PROCESS DESIGN

(71) Applicant: GM GLOBAL TECHNOLOGY OPERATIONS LLC, Detroit, MI (US)

(72) Inventors: Arkadi Vinnik, Ann Arbor, MI (US); John B. Katona, JR., Holly, MI (US); Paul S. Hornung, Shelby Township, MI (US)

(73) Assignee: GM GLOBAL TECHNOLOGY OPERATIONS LLC, Detroit, MI (US)

(21) Appl. No.: 15/659,234

(22) Filed: Jul. 25, 2017

(51) Int. Cl. G06F 17/30; G06F 17/50; G06N 5/02

(52) U.S. Cl. CPC G06F 17/30274; G06F 2216/03; G06N 5/025; G06F 17/50

(57) ABSTRACT

A method for using business intelligence for generating rules for a manufacturing process design has been developed. First, product properties are extracted from a product lifecycle management/product data management (PLM/PDM) system(s). Next, process data is extracted from a manufacturing database and then manufacturing production data is extracted from the PLM/PDM system(s). All the extracted data is stored in a data mining database. The contents of the data mining database are then analyzed by data mining system, which generates decision tree; an automatic rule generator is used to create manufacturing process rules from the decision tree. The process rules are then stored in a process rules database for use by an automated or semi-automated process design engine.

### TECHNICAL FIELD

The technical field generally relates to manufacturing processes, and more particularly relates to designing a manufacturing process using a rules generation process based on business intelligence.

### INTRODUCTION

Manufacturing is continually becoming more sophisticated reflecting the drive to reduce size, weight and therefore, cost of products while maintaining and improving quality. For example, the typical architecture in the automotive industry utilizes thousands of components that are assembled in a complex order. Coupling these vast numbers of components with a myriad of unique constrained operations is a cumbersome task to design an efficient manufacturing process. Consequently, creation of rules for the manufacturing process design may be very lengthy and difficult. Additionally, many rules are sometimes incorrect and not applicable to specific plants, lines or processes.

Accordingly, it is desirable to automate the process of rules generation for design of manufacturing process with a method that allows rules generation using business intelligence. Furthermore, other desirable features and characteristics of the present invention will become apparent from the subsequent detailed description and the appended claims, taken in conjunction with the accompanying drawings and the foregoing technical field and background.

### SUMMARY

A method is provided for using business intelligence for generating rules for a manufacturing process design. In one embodiment, the apparatus includes extracting product properties from a product lifecycle management/product data management (PLM/PDM) system(s) and storing the properties in a data mining database; extracting process data from a manufacturing database (independent or PLM/PDM based) and storing the process data in the data mining database; extracting manufacturing production data from the PLM/PDM system(s) and storing the manufacturing production data in the data mining database; analyzing the contents of the data mining database and extracting a decision tree for use in creating manufacturing process rules; creating manufacturing process rules with an automatic rule generator based on the analysis of the decision tree; and storing the manufacturing process rules in a process rules database for retrieval by an automated process design engine.

A system is provided for automatically designing a manufacturing process. In one embodiment, the method includes: a system that extracts, product properties from a computer aided design (CAD) data (most likely stored in PLM/PDM system), process data from a process database, and manufacturing production data from a product lifecycle management/product data management (PLM/PDM) system(s), where the properties and data are stored in a data mining database; a data mining system that analyzes the contents of the data mining database and generates process design decision tree; an automatic rule generator that creates process rules based on the analysis of the decision tree; a rules database manager that stores the rules in a process rules database; and a process design engine that retrieves the process rules from the process rules database and uses the process rules to design a manufacturing process(es).

### BRIEF DESCRIPTION OF THE DRAWINGS

The exemplary embodiments will hereinafter be described in conjunction with the following drawing figures, wherein like numerals denote like elements, and wherein:

FIG. 1 is a diagram showing the design of a manufacturing process utilizing a rules database in accordance with an embodiment;

FIG. 2 is a diagram showing a business intelligence engine that is used to generate process rules for a manufacturing process in accordance with an embodiment; and

FIG. 3 is a data flowchart showing the generation of a process rules database by a business intelligence engine in accordance with an embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

A system and method for designing a manufacturing process using a rules-based engine has been developed. The rules engine allows the automatic generation of a manufacturing process where the rules are generated by analyzing existing manufacturing processes and extracting product and manufacturing properties. Embodiments of the method allow automatic generation and/or verification of manufacturing process. Additionally, embodiments of the method allow for ongoing and continuous optimization, maintenance and refinement of the process.

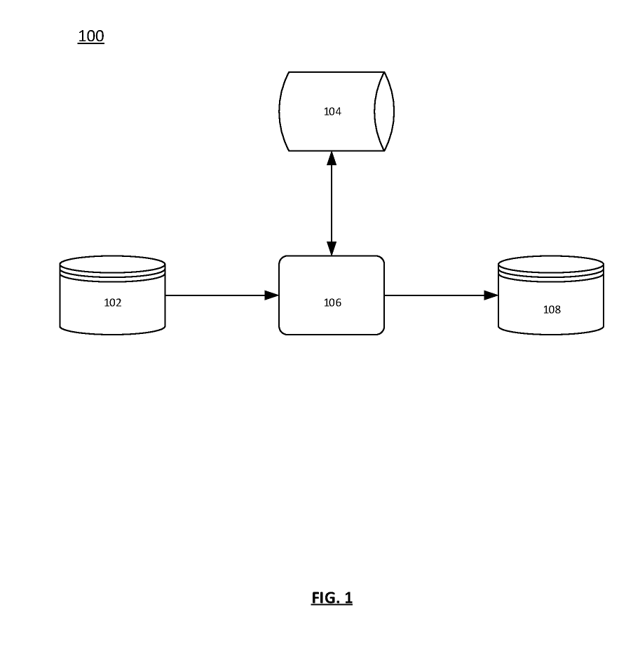

Turning now to FIG. 1, a diagram is shown of the design of a manufacturing process utilizing a rules database 100 in accordance with one embodiment. In this embodiment, the vehicle design data 102 is extracted from a database and loaded into a process design engine 106. The process design engine 106 continually accesses process rules from the rules database 104. Once the manufacturing process is complete, the entire design of the manufacturing process is finalized and stored in a database 108.

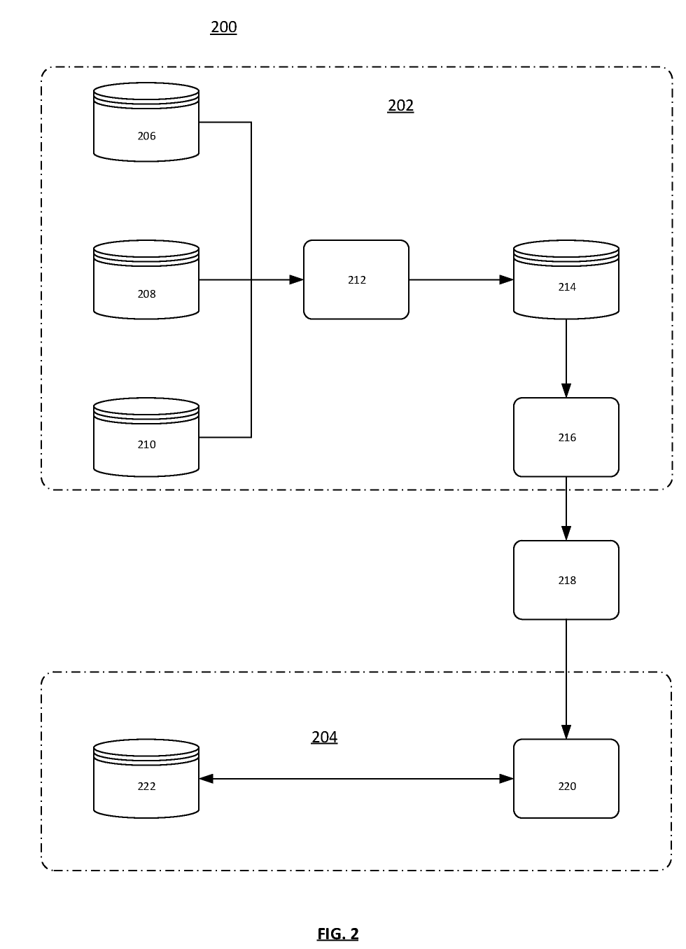

Turning now to FIG. 2 with continued reference to FIG. 1, a diagram is shown of a system with a business intelligence engine that is used to generate process rules for a manufacturing process 200 in accordance with one embodiment. In this embodiment, the business intelligence engine 202 extracts product properties 206 from product design data. Also, manufacturing process data 208 is extracted from a manufacturing process database. Finally, manufacturing production data 210 is extracted from manufacturing databases including the factory assembly line layout, available equipment, available tools, fixtures, work-in process assemblies, etc. Once these properties and data are extracted 212, they are stored in a data mining database 214. The contents of the data mining database 214 is analyzed by data mining system. The system 216 extracts and analyzes the data for each element in the manufacturing process and generates manufacturing process creation decision tree. The generated decision tree utilizes: sequence of process operations; assembly-line sequence; available manufacturing equipment; available manufacturing tools, configuration requirements for manufacturing equipment; configuration requirements for manufacturing tools; recommended ergonomic positions for human workers; process requirements; line balancing; etc. The decision tree is the input for an automatic rule generator 218 which generates the process rules for a rule management engine 204. The process rules are handled by a rules database manager 220 which stores them in a database 222 for retrieval and use by the process design engine shown in FIG. 1.

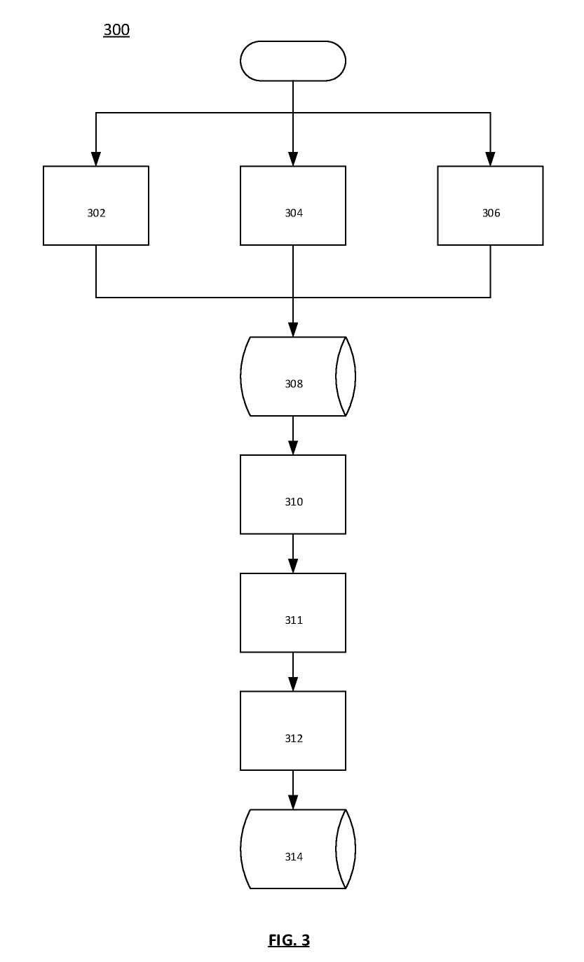

Turning now to FIG. 3 with continued reference to FIGS. 1 and 2, a flowchart is shown of a method for generating process rules for a manufacturing process with a business intelligence engine 300 in accordance with one embodiment. In this embodiment, product properties from the design are extracted from a product lifecycle management/product data management (PLM/PDM) system(s) 302. Additionally, product properties may be extracted from a computer aided design (CAD) resource in other embodiments. Process data from the manufacturing process database is extracted from the PLM/PDM system(s) and/or a manufacturing database 304. Also, manufacturing production data is extracted from manufacturing database 306. The manufacturing production data may include factory assembly line layout, available manufacturing equipment, available manufacturing tools, etc. The extracted data and properties are shown being extracted in parallel. However, each may be extracted sequentially in any order in other embodiments. These data and properties are stored in a data mining database 308. The contents of the data mining database 308 is analyzed by a data mining system 310 and decision tree for process creation is extracted 311. The results of the decision tree 311 is used to create process rules 312 that are stored in a process rules database 314 for retrieval and use in designing the manufacturing process.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for using business intelligence for generating rules for a manufacturing process design, comprising:
extracting current and historical product properties from a product lifecycle management/product data management (PLM/PDM) system(s) and storing the properties in a data mining database;
extracting current and historical process data from a manufacturing database (independent or PLM/PDM based) and storing the process data in the data mining database;
extracting current and historical manufacturing production data from a PLM/PDM system(s) or independent database(s) and storing the manufacturing production data (layout, equipment, tools, etc.) in the data mining database;
analyzing the contents of the data mining database and extracting a decision tree for use in creating manufacturing process rules;
creating manufacturing process rules with an automatic rules generator based on the analysis of the generated decision tree;
and storing the manufacturing process rules in a process rules database for use by automated or semi-automated process design engine(s).

2. The method of claim 1, where the contents of the data mining database are analyzed based on the sequence and content of manufacturing process operations, in-process (work in process) assemblies, available manufacturing equipment, tools and human operators.

3. The method of claim 1, where the product properties are extracted from a computer aided design (CAD), PLM and PDM resources.

4. The method of claim 1, where the process data is extracted from a manufacturing database (independent or PLM/PDM based).

5. The method of claim 1, where the data mining system analyzes the contents of the data mining database based on available manufacturing equipment.

6. The method of claim 1, where the data mining system analyzes the contents of the data mining database based on available human operators.

7. The method of claim 1, where the data mining system analyzes the contents of the data mining database based on process parameters.

8. The method of claim 1, where the data mining system analyzes the contents of the data mining database based on manufacturing production parameters.

9. The method of claim 1, where the data mining system analyzes the contents of the data mining database based on recommended ergonomic positions for human operators.

10. The method of claim 1, where the data mining system analyzes the contents of the data mining database based on configuration parameters for manufacturing equipment.

11. The method of claim 1, where the data mining system analyzes the contents of the data mining database based on configuration parameters for manufacturing tools.
